(19) United States
(12) Patent Application Publication
(10) Pub. No.: US 2020/0294692 A1
(43) Pub. Date: Sep. 17, 2020

(54) CABLE AND ULTRASONIC DEVICE

(71) Applicant: SEIKO EPSON CORPORATION, Tokyo (JP)

(72) Inventors: Yoshio ARAI, Shiojiri-shi (JP); Mitsuru MIYASAKA, Shiojiri-shi (JP); Masayoshi YAMADA, Chino-shi (JP); Kanechika KIYOSE, Matsumoto-shi (JP)

(73) Assignee: SEIKO EPSON CORPORATION, Tokyo (JP)

(21) Appl. No.: 16/814,140

(22) Filed: Mar. 10, 2020

(30) Foreign Application Priority Data
Mar. 11, 2019 (JP) 2019-043909

(51) Int. Cl. H01B 11/06; H01B 11/20; H01B 7/22; H01B 7/04; G10K 11/24; G01N 29/34

(52) U.S. Cl. CPC H01B 11/06; H01B 11/20; G01N 29/34; H01B 7/04; G10K 11/24; H01B 7/22

(57) ABSTRACT

A cable has a core line. The core line includes a signal line transmitting a signal, a ground line having a ground potential, and a shield line covering the signal line and the ground line. The ground line and the shield line are electrically coupled together.

The present application is based on, and claims priority from JP Application Serial Number 2019-043909, filed Mar. 11, 2019, the disclosure of which is hereby incorporated by reference herein in its entirety.

### BACKGROUND

### 1. Technical Field

The present disclosure relates to a cable and an ultrasonic device.

### 2. Related Art

JP-A-2014-241209 discloses a cable having a plurality of inner cables and a braided shield provided at an outer circumference of the inner cables and formed of wires braided together.

In the cable of JP-A-2014-241209, the braided shield covers the inner cables and thus provides a shielding effect in which the influence of an external noise is reduced.

However, for example, when the cable described in JP-A-2014-241209 is bent, the wires forming the braided shield may be broken, posing the risk of reducing the shielding effect.

### SUMMARY

A cable according to a first application example of the present disclosure includes a core line. The core line includes a signal line transmitting a signal, a ground line having a ground potential, and a shield line covering the signal line and the ground line. The ground line and the shield line are electrically coupled together.

In the cable according to the application example, the shield line may be formed of a plurality of wires formed of a conductor and braided together.

In the cable according to the application example, the shield line may be formed of a wire formed of a conductor and helically wrapped.

In the cable according to the application example, the shield line may include a signal shield line covering the signal line, and a ground shield line covering the ground line. The signal shield line and the ground shield line may be electrically coupled to the ground line.

In the cable according to the application example, the signal line may include a transmission signal line transmitting a drive signal between a first piezoelectric element transmitting an ultrasonic wave and a transmitting circuit controlling transmission of an ultrasonic wave, and a reception signal line transmitting a reception signal between a second piezoelectric element receiving an ultrasonic wave and a receiving circuit controlling reception of an ultrasonic wave. The signal shield line may include a transmission shield line covering the transmission signal line, and a reception shield line covering the reception signal line. The transmission shield line and the reception shield line may be electrically coupled to the ground line.

In the cable according to the application example, the ground line may include a first ground line and a second ground line. The transmission shield line may be electrically coupled to the first ground line. The reception shield line may be electrically coupled to the second ground line.

In the cable according to the application example, the ground line may include a first ground line and a second ground line. The transmission shield line and the reception shield line may be electrically coupled to the first ground line and the second ground line.

In the cable according to the application example, the ground line and the shield line may be electrically coupled together at both ends.

An ultrasonic device according to a second application example includes: the cable according to the first application example; an ultrasonic sensor coupled to one end of the cable; and a control unit coupled to the other end of the cable and controlling the ultrasonic sensor.

### BRIEF DESCRIPTION OF THE DRAWINGS

FIG. 1 is a block diagram showing a schematic configuration of an ultrasonic device according to a first embodiment.

FIG. 2 is a partly broken perspective view showing essential parts at an end of the cable according to the first embodiment.

FIG. 3 is a partly broken perspective view showing essential parts at an end of a cable according to a second embodiment.

FIG. 4 is a partly broken perspective view showing essential parts at an end of a cable according to a third embodiment.

FIG. 5 is a partly broken perspective view showing essential parts at an end of a cable according to a fourth embodiment.

FIG. 6 is a block diagram showing essential parts of an ultrasonic device according to a modification example.

### DESCRIPTION OF EXEMPLARY EMBODIMENTS

### First Embodiment

An ultrasonic device 100 according to a first embodiment of the present disclosure will now be described with reference to the drawings.

### Schematic Configuration of Ultrasonic Device 100

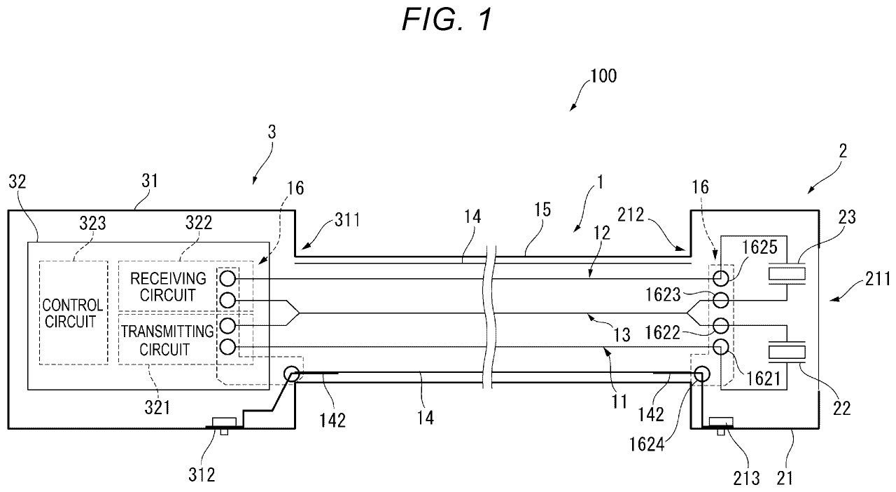

FIG. 1 is a block diagram showing a schematic configuration of the ultrasonic device 100 according to this embodiment.

As shown in FIG. 1, the ultrasonic device 100 has a cable 1, an ultrasonic sensor 2, and a control device 3.

The ultrasonic device 100 according to this embodiment transmits an ultrasonic wave to a target object from the ultrasonic sensor 2 and receives the ultrasonic wave reflected off the target object. The ultrasonic device 100 is configured as a distance measuring device calculating the distance from the ultrasonic sensor 2 to the target object, based on the time from the timing of transmitting the ultrasonic wave to the timing of receiving the ultrasonic wave.

### Ultrasonic Sensor 2

The ultrasonic sensor 2 has a probe casing 21, a transmitting element 22, and a receiving element 23.

The probe casing 21 accommodates the transmitting element 22 and the receiving element 23. The probe casing 21 is provided with a sensor window 211 at a position corresponding to the transmitting element 22 and the receiving element 23.

The probe casing 21 is also provided with a passage hole 212. The cable 1 is inserted in the probe casing 21 via the passage hole 212. Thus, the ultrasonic sensor 2 is coupled to one end of the cable 1.

The probe casing 21 is also provided with a probe frame ground 213 to which an outer circumferential shield line 14 of the cable 1, described later, is electrically coupled.

The transmitting element 22 has a piezoelectric film, not illustrated. The transmitting element 22 is configured to be able to send out an ultrasonic wave as the piezoelectric film vibrates when a drive signal is applied thereto. The transmitting element 22 is an example of the first piezoelectric element according to the present disclosure.

A transmission signal line 111 and a ground line 131 of the cable 1, described later, are electrically coupled to the transmitting element 22.

The receiving element 23 has a piezoelectric film, not illustrated, similarly to the transmitting element 22. When the piezoelectric film vibrates due to the ultrasonic wave sent out from the transmitting element 22 and reflected off the target object, a potential difference is generated between above and below the piezoelectric film. Thus, the receiving element 23 is configured to be able to output a reception signal corresponding to the ultrasonic wave by detecting the potential difference. The receiving element 23 is an example of the second piezoelectric element according to the present disclosure.

A reception signal line 121 and the ground line 131 of the cable 1, described later, are electrically coupled to the receiving element 23.

### Control Device 3

The control device 3 has a control device casing 31 and a circuit board 32. The control device 3 is an example of the control unit according to the present disclosure.

The control device casing 31 accommodates the circuit board 32. The control device casing 31 is provided with a passage hole 311. The cable 1 is inserted in the control device casing 31 via the passage hole 311. Thus, the control device 3 is coupled to the other end of the cable 1.

The control device casing 31 is also provided with a control device frame ground 312 to which the outer circumferential shield line 14 of the cable 1, described later, is electrically coupled.

The circuit board 32 has a transmitting circuit 321, a receiving circuit 322, and a control circuit 323.

The transmitting circuit 321 is a signal output unit controlled by the control circuit 323 and outputting a drive signal. The transmitting circuit 321 is electrically coupled to the transmitting element 22 via the cable 1. Thus, the transmitting circuit 321 outputs the drive signal to the transmitting element 22 via the cable 1.

The receiving circuit 322 takes in and processes a reception signal outputted from the receiving element 23 via the cable 1. Specifically, the receiving circuit 322 includes, for example, a low-noise amplifier circuit, voltage-controlled attenuator, programmable gain amplifier, low-pass filter, A/D converter or the like. The receiving circuit 322 performs various kinds of signal processing such as converting the reception signal to a digital signal, eliminating a noise component, and amplifying the reception signal to a desired signal level, and subsequently outputs the processed reception signal to the control circuit 323.

The control circuit 323 is formed of, for example, a computing circuit such as a CPU, and a storage circuit such as a memory. The control circuit 323 controls the transmitting circuit 321 and the receiving circuit 322. The control circuit 323 calculates the distance from the ultrasonic sensor 2 to the target object by a ToF (time-of-flight) technique, using the time from when the ultrasonic sensor 2 transmits the ultrasonic wave to when the reception signal is detected, and the speed of sound in the air.

### Cable 1

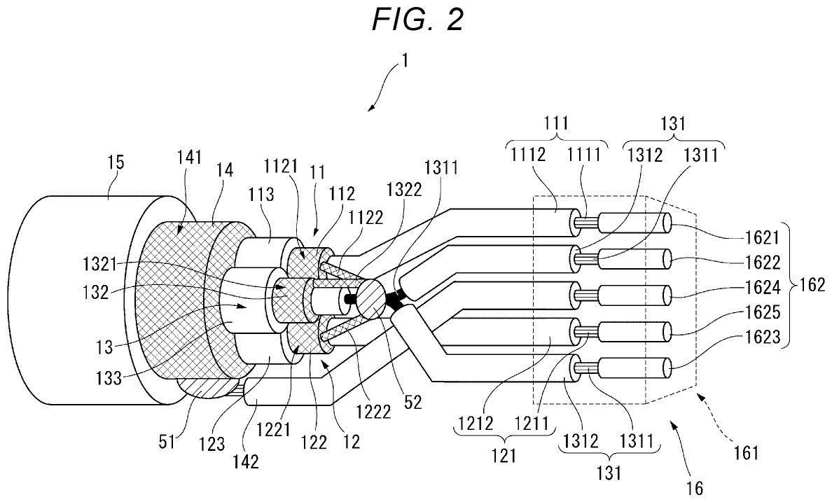

FIG. 2 is a partly broken perspective view showing essential parts at an end of the able 1.

As shown in FIGS. 1 and 2, the cable 1 is a coaxial cable extending between the ultrasonic sensor 2 and the control device 3 and electrically coupling these together.

The cable 1 has a transmission signal core line 11, a reception signal core line 12, a ground core line 13, an outer circumferential shield line 14, an outer cover 15, and a connector unit 16. The transmission signal core line 11, the reception signal core line 12, and the ground core line 13 form the core line according to the present disclosure.

### Transmission Signal Core Line 11

As shown in FIG. 2, the transmission signal core line 11 has a transmission signal line 111, a transmission shield line 112, and a transmission shield cover 113.

The transmission signal line 111 electrically couples the transmitting element 22 of the ultrasonic sensor 2 and the transmitting circuit 321 of the control device 3 to each other. Thus, the transmission signal line 111 transmits a drive signal outputted from the transmitting circuit 321 to the transmitting element 22. The transmission signal line 111 forms the signal line according to the present disclosure.

The transmission signal line 111 has a transmission conductor 1111 and a transmission conductor cover 1112.

The transmission conductor 1111 is formed of a copper wire and transmits a drive signal. However, the transmission conductor 1111 is not limited to being formed of a copper wire and may be formed of a conductor of a metal material such as a copper alloy or aluminum.

The transmission conductor cover 1112 is formed of a polyethylene member and covers the transmission conductor 1111. This can prevent a short circuit between the transmission conductor 1111 and the transmission shield line 112. The transmission conductor cover 1112 is not limited to being formed of a polyethylene member and may be formed of any insulating material.

The transmission shield line 112 is formed as a braided shield formed of a plurality of wires 1121 braided together, and covers the transmission signal line 111. In this embodiment, the wire 1121 is formed of a copper foil thread. The transmission shield line 112 has, at its both ends, a transmission shield lead wire 1122 formed of a plurality of wires 1121 stranded together.

The wire 1121 is not limited to being formed of a copper foil thread and may be formed of a conductor of a metal material such as a copper alloy or aluminum.

The transmission shield line 112 forms the shield line according to the present disclosure. The transmission shield line 112 also forms the signal shield line according to the present disclosure.

The transmission shield cover 113 is formed of a polyethylene member and covers the transmission shield line 112. This can prevent a short circuit between the transmission shield line 112, and the reception signal core line 12 and the ground core line 13. The transmission shield cover 113 is not limited to being formed of a polyethylene member and may be formed of any insulating material.

### Reception Signal Core Line 12

The reception signal core line 12 has a reception signal line 121, a reception shield line 122, and a reception shield cover 123.

The reception signal line 121 electrically couples the receiving element 23 of the ultrasonic sensor 2 and the receiving circuit 322 of the control device 3 to each other. Thus, the reception signal line 121 transmits a reception signal outputted from the receiving element 23 to the receiving circuit 322. The reception signal line 121 forms the signal line according to the present disclosure.

The reception signal line 121 has a reception conductor 1211 and a reception conductor cover 1212.

The reception conductor 1211 is formed of a copper wire and transmits a reception signal. However, the reception conductor 1211 is not limited to being formed of a copper wire and may be formed of a conductor of a metal material such as a copper alloy or aluminum.

The reception conductor cover 1212 is formed of a polyethylene member and covers the circumference of the reception conductor 1211. This can prevent a short circuit between the reception conductor 1211 and the reception shield line 122. The reception conductor cover 1212 is not limited to being formed of a polyethylene member and may be formed of any insulating material.

The reception shield line 122 is formed as a braided shield formed of a plurality of wires 1221 braided together, and covers the reception signal line 121. In this embodiment, the wire 1221 is formed of a copper foil thread. The reception shield line 122 has, at its both ends, a reception shield lead wire 1222 formed of a plurality of wires 1221 stranded together.

The wire 1221 is not limited to being formed of a copper foil thread and may be formed of a conductor of a metal material such as a copper alloy or aluminum.

The reception shield line 122 forms the shield line according to the present disclosure. The reception shield line 122 also forms the signal shield line according to the present disclosure.

The reception shield cover 123 is formed of a polyethylene member and covers the reception shield line 122. This can prevent a short circuit between the reception shield line 122, and the transmission signal core line 11 and the ground core line 13. The reception shield cover 123 is not limited to being formed of a polyethylene member and may be formed of any insulating material.

### Ground Core Line 13

The ground core line 13 has a ground line 131, aground shield line 132, and a ground shield cover 133.

The ground line 131 electrically couples a ground terminal of the transmitting element 22 of the ultrasonic sensor 2 and a ground terminal of the transmitting circuit 321 of the control device 3 to each other. Thus, the ground terminal of the transmitting element 22 has the same ground potential as the transmitting circuit 321.

The ground line 131 also electrically couples a ground terminal of the receiving element 23 of the ultrasonic sensor 2 and a ground terminal of the receiving circuit 322 of the control device 3 to each other. Thus, the ground terminal of the receiving element 23 has the same ground potential as the receiving circuit 322.

The ground line 131 has a ground conductor 1311 and a ground conductor cover 1312 and bifurcates at its both ends.

The ground conductor 1311 is formed of a copper wire and has a ground potential. However, the ground conductor 1311 is not limited to being formed of a copper wire and may be formed of a conductor of a metal material such as a copper alloy or aluminum.

The ground conductor cover 1312 is formed of a polyethylene member and covers the ground conductor 1311. This can prevent a short circuit between the ground conductor 1311 and the ground shield line 132. The ground conductor cover 1312 is not limited to being formed of a polyethylene member and may be formed of any insulating material.

The ground shield line 132 is formed as a braided shield formed of a plurality of wires 1321 braided together, and covers the ground line 131. In this embodiment, the wire 1321 is formed of a copper foil thread. The ground shield line 132 has, at its both ends, a ground shield lead wire 1322 formed of a plurality of wires 1321 stranded together.

The wire 1321 is not limited to being formed of a copper foil thread and may be formed of a conductor of a metal material such as a copper alloy or aluminum.

The ground shield line 132 forms the shield line according to the present disclosure.

The ground shield cover 133 is formed of a polyethylene member and covers the ground shield line 132. This can prevent a short circuit between the ground shield line 132, and the transmission signal core line 11 and the reception signal core line 12. The ground shield cover 133 is not limited to being formed of a polyethylene member and may be formed of any insulating material.

The transmission signal core line 11, the reception signal core line 12, and the ground core line 13 form the core line according to the present disclosure.

### Outer Circumferential Shield Line 14

The outer circumferential shield line 14 is formed as a braided shield formed of a plurality of wires 141 braided together, and covers the transmission signal core line 11, the reception signal core line 12, and the ground core line 13. In this embodiment, the wire 141 is formed of a copper foil thread. The outer circumferential shield line 14 has, at its both ends, an outer circumferential shield lead wire 142. In this embodiment, the outer circumferential shield lead wire 142 is coupled to the outer circumferential shield line 14 by a solder part 51.

The outer circumferential shield lead wire 142 coupled to the end on the side of the ultrasonic sensor 2 is electrically coupled to the probe frame ground 213 of the probe casing 21 via the connector unit 16. The outer circumferential shield lead wire 142 coupled to the end on the side of the control device 3 is electrically coupled to the control device frame ground 312 of the control device casing 31 via the connector unit 16.

### Outer Cover 15

The outer cover 15 is formed of a polyethylene member and covers the outer circumferential shield line 14. This can prevent a short circuit between the outer circumferential shield line 14 and another external wiring and can also prevent damage to the outer circumferential shield line 14. The outer cover 15 is not limited to being formed of a polyethylene member and may be formed of an insulating material having weather resistance, wear resistance, and the like.

### Connector Unit 16

The connector unit 16 is a coupling member provided at both ends of the cable 1 and electrically coupling the ultrasonic sensor 2 and the control device 3 to each other. Specifically, the connector unit 16 provided at one end of the cable 1 is configured to be able to be coupled to a connector, not illustrated, provided in the ultrasonic sensor 2. The connector unit 16 provided at the other end of the cable 1 is configured to be able to be coupled to a connector, not illustrated, provided in the control device 3.

FIG. 2 shows only the connector unit 16 provided at the one end of the cable 1, that is, coupled to the connector of the ultrasonic sensor 2. The connector unit 16 provided at the other end of the cable 1, that is, coupled to the connector of the control device 3, is similar to the connector unit 16 shown in FIG. 2 and therefore will not be described.

The connector unit 16 has a connector housing 161 and a connector crimp terminal 162. The connector housing 161 is formed of a polyamide resin and configured to be able to engage with a housing of the connector, not illustrated, of the ultrasonic sensor 2. The connector housing 161 accommodates the connector crimp terminal 162. The connector housing 161 is not limited to being formed of a polyamide resin and may be formed of, for example, a phenol resin.

The connector crimp terminal 162 is formed of an oxygen-free copper tube and has a transmitting terminal 1621, a first common ground terminal 1622, a second common ground terminal 1623, a frame ground terminal 1624, and a receiving terminal 1625. Terminals corresponding to these terminals 1621 to 1625 are provided in the connector, not illustrated, provided in the ultrasonic sensor 2.

To the transmitting terminal 1621, the transmission conductor 1111 of the transmission signal line 111 is coupled. Thus, the transmission signal line 111 is electrically coupled to the transmitting element 22 via the transmitting terminal 1621.

To the first common ground terminal 1622, one of the bifurcated parts of the ground conductor 1311 is coupled. Thus, the ground line 131 is electrically coupled to the transmitting element 22 via the first common ground terminal 1622.

To the second common ground terminal 1623, the other one of the bifurcated parts of the ground conductor 1311 is coupled. Thus, the ground line 131 is electrically coupled to the receiving element 23 via the second common ground terminal 1623.

To the frame ground terminal 1624, the outer circumferential shield lead wire 142 of the outer circumferential shield line 14 is coupled. Thus, the outer circumferential shield line 14 is electrically coupled to the probe frame ground 213 via the frame ground terminal 1624.

To the receiving terminal 1625, the reception conductor 1211 of the reception signal line 121 is coupled. Thus, the reception signal line 121 is electrically coupled to the receiving element 23 via the receiving terminal 1625.

The shielding effect of the outer circumferential shield line 14 drops at the part where the outer circumferential shield lead wire 142 is pulled around. Therefore, a shielded connector having the connector crimp terminal 162 surrounded by a metal may be used as the connector unit 16.

### Coupling between Ground Line 131 and Respective Shield Lines 112, 122, 132

The coupling between the ground line 131 and the respective shield lines 112, 122, 132 will now be described.

As shown in FIG. 2, at the one end of the cable 1, the ground conductor 1311 of the ground line 131 and the transmission shield lead wire 1122 of the transmission shield line 112 are coupled together by a solder part 52. Also, the ground conductor 1311 and the reception shield lead wire 1222 of the reception shield line 122 are coupled together by the solder part 52. Moreover, the ground conductor 1311 and the ground shield lead wire 1322 of the ground shield line 132 are coupled together by the solder part 52. That is, the transmission shield lead wire 1122, the reception shield lead wire 1222, and the ground shield lead wire 1322, and the ground conductor 1311 are coupled together by the solder part 52. Thus, the transmission shield line 112, the reception shield line 122, and the ground shield line 132 are electrically coupled to the ground line 131.

At the other end of the cable 1, the transmission shield line 112, the reception shield line 122, and the ground shield line 132 are electrically coupled to the ground line 131, similarly to the above.

Thus, the transmission shield line 112, the reception shield line 122, the ground shield line 132 and the ground line 131 are electrically coupled together at both ends.

### Advantageous Effects of First Embodiment

The first embodiment as described above can achieve the following effects.

In this embodiment, the ultrasonic device 100 has the cable 1, the ultrasonic sensor 2, and the control device 3.

The transmission shield line 112, the reception shield line 122, the ground shield line 132, and the ground line 131 of the cable 1 are electrically coupled together at both ends.

Thus, for example, even when the wires 1121, 1221, 1321 are broken as the cable 1 is bent, the respective shield lines 112, 122, 132 can release a noise such as an electromagnetic wave via the ground line 131. Therefore, the shielding effect can be maintained even when the wires 1121, 1221, 1321 are broken.

In this embodiment, each of the shield lines 112, 122, 132 is formed as a braided shield formed of a plurality of wires 1121, 1221, 1321 formed of conductive copper foil threads and braided together.

Thus, since the braided shield is very flexible, the wires 1121, 1221, 1321 can be made less likely to be broken when the cable 1 is bent. Therefore, a reduction in the shielding effect can be restrained in the respective shield lines 112, 122, 132.

In this embodiment, the cable 1 has the transmission signal line 111 transmitting a drive signal between the transmitting element 22 and the transmitting circuit 321, and the reception signal line 121 transmitting a reception signal between the receiving element 23 and the receiving circuit 322.

Thus, in the ultrasonic device 100, the influence of a noise such as an electromagnetic wave on the drive signal and the reception signal can be restrained.

### Second Embodiment

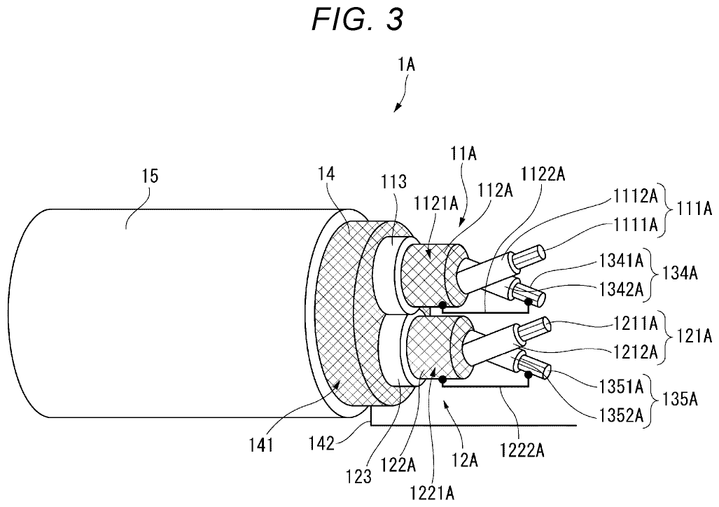

A second embodiment of the present disclosure will now be described with reference to FIG. 3. The second embodiment is different from the first embodiment in that a transmission signal line 111A and a first ground line 134A are formed as a twisted pair cable. The second embodiment is also different from the first embodiment in that a reception signal line 121A and a second ground line 135A are formed as a twisted pair cable.

In the second embodiment, a component identical or similar to that in the first embodiment is denoted by the same reference sign and its description is omitted or simplified.

FIG. 3 is a partly broken cross-sectional view showing essential parts at an end of a cable 1A according to the second embodiment.

As shown in FIG. 3, the cable 1A has a transmission signal core line 11A and a reception signal core line 12A.

### Transmission Signal Core Line 11A

The transmission signal core line 11A has a transmission signal line 111A, a first ground line 134A, a transmission shield line 112A, and a transmission shield cover 113.

The transmission signal core line 11A transmits a drive signal outputted from the transmitting circuit 321 to the transmitting element 22, as in the first embodiment.

The transmission signal line 111A has a transmission conductor 1111A and a transmission conductor cover 1112A. In this embodiment, the transmission conductor 1111A and the transmission conductor cover 1112A are formed similarly to the transmission conductor 1111 and the transmission conductor cover 1112 in the first embodiment.

The first ground line 134A electrically couples the ground terminal of the transmitting element 22 of the ultrasonic sensor 2 and the ground terminal of the transmitting circuit 321 of the control device 3 to each other. Thus, the ground terminal of the transmitting element 22 has the same ground potential as the ground terminal of the transmitting circuit 321.

The first ground line 134A has a first ground conductor 1341A and a first ground conductor cover 1342A. In this embodiment, the first ground conductor 1341A and the first ground conductor cover 1342A are formed similarly to the ground conductor 1311 and the ground conductor cover 1312 in the first embodiment.

In this embodiment, the transmission signal line 111A and the first ground line 134A are stranded together and formed as a twisted pair cable.

The transmission shield line 112A is formed as a braided shield formed of a plurality of wires 1121A braided together, as in the first embodiment.

In this embodiment, the transmission shield line 112A covers the transmission signal line 111A and the first ground line 134A stranded together.

The transmission shield line 112A has, at its both ends, a transmission shield lead wire 1122A formed of a plurality of wires 1121A stranded together. The transmission shield lead wire 1122A is coupled to the first ground line 134A. Thus, the transmission shield line 112A and the first ground line 134A are electrically coupled together at both ends.

### Reception Signal Core Line 12A

The reception signal core line 12A has a reception signal line 121A, a second ground line 135A, a reception shield line 122A, and a reception shield cover 123.

The reception signal line 121A outputs a reception signal outputted from the receiving element 23 to the receiving circuit 322, as in the first embodiment.

The reception signal line 121A has a reception conductor 1211A and a reception conductor cover 1212A. In this embodiment, the reception conductor 1211A and the reception conductor cover 1212A are formed similarly to the reception conductor 1211 and the reception conductor cover 1212 in the first embodiment.

The second ground line 135A electrically couples the ground terminal of the receiving element 23 of the ultrasonic sensor 2 and the ground terminal of the receiving circuit 322 of the control device 3 to each other. Thus, the ground terminal of the receiving element 23 has the same ground potential as the ground terminal of the receiving circuit 322.

The second ground line 135A has a second ground conductor 1351A and a second ground conductor cover 1352A. In this embodiment, the second ground conductor 1351A and the second ground conductor cover 1352A are formed similarly to the ground conductor 1311 and the ground conductor cover 1312 in the first embodiment.

In this embodiment, the reception signal line 121A and the second ground line 135A are stranded together and formed as a twisted pair cable.

The reception shield line 122A is formed as a braided shield formed of a plurality of wires 1221A braided together, as in the first embodiment.

In this embodiment, the reception shield line 122A covers the reception signal line 121A and the second ground line 135A stranded together.

The reception shield line 122A has, at its both ends, a reception shield lead wire 1222A formed of a plurality of wires 1221A stranded together. The reception shield lead wire 1222A is coupled to the second ground line 135A. Thus, the reception shield line 122A and the second ground line 135A are electrically coupled together at both ends.

### Advantageous Effects of Second Embodiment

The second embodiment as described above can achieve the following effects.

In this embodiment, the transmission shield line 112A and the first ground line 134A are electrically coupled together.

Thus, even when the wire 1121A is broken, the transmission shield line 112A can release a noise such as an electromagnetic wave via the first ground line 134A. Therefore, the shielding effect can be maintained even when the wire 1121A is broken.

The transmission signal line 111A and the first ground line 134A are stranded together and formed as a twisted pair cable.

Therefore, the influence of a noise such as an electromagnetic wave on the drive signal transmitted through the transmission signal line 111A can be restrained.

In this embodiment, the reception shield line 122A and the second ground line 135A are electrically coupled together.

Thus, even when the wire 1221A is broken, the reception shield line 122A can release a noise such as an electromagnetic wave via the second ground line 135A. Therefore, the shielding effect can be maintained even when the wire 1221A is broken.

The reception signal line 121A and the second ground line 135A are stranded together and formed as a twisted pair cable.

Therefore, the influence of a noise such as an electromagnetic wave on the reception signal transmitted through the reception signal line 121A can be restrained.

### Third Embodiment

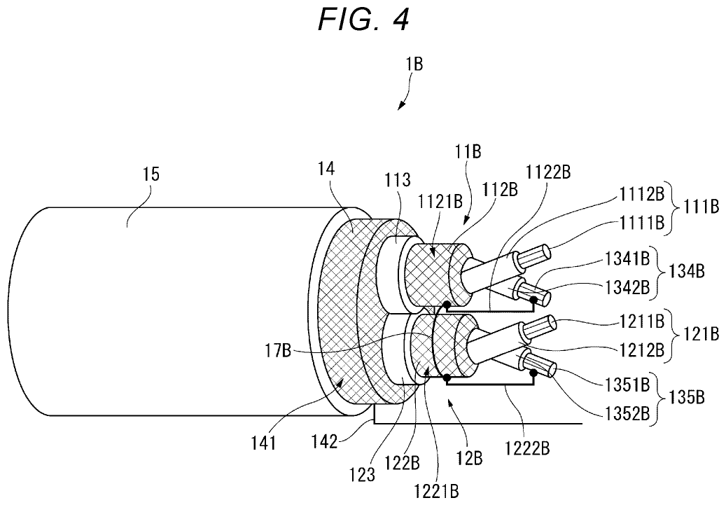

A third embodiment of the present disclosure will now be described with reference to FIG. 4. The third embodiment is different from the second embodiment in that a transmission shield line 112B and a reception shield line 122B are electrically coupled to a first ground line 134B and a second ground line 135B.

In the third embodiment, a component identical or similar to that in the first and second embodiments is denoted by the same reference sign and its description is omitted or simplified.

FIG. 4 is a partly broken cross-sectional view showing essential parts at an end of a cable 1B according to the third embodiment.

As shown in FIG. 4, the cable 1B has a transmission signal core line 11B and a reception signal core line 12B.

### Transmission Signal Core Line 11B

The transmission signal core line 11B has a transmission signal line 111B, a first ground line 134B, a transmission shield line 112B, and a transmission shield cover 113.

The transmission signal line 111B has a transmission conductor 1111B and a transmission conductor cover 1112B.

The first ground line 134B has a first ground conductor 1341B and a first ground conductor cover 1342B.

In this embodiment, the transmission signal line 111B and the first ground line 134B are stranded together and formed as a twisted pair cable, as in the second embodiment.

The transmission shield line 112B is formed as a braided shield formed of a plurality of wires 1121B braided together, as in the first and second embodiments.

The transmission shield line 112B has, at its both ends, a transmission shield lead wire 1122B formed of a plurality of wires 1121B stranded together. The transmission shield lead wire 1122B is coupled to the first ground line 134B, as in the second embodiment. Thus, the transmission shield line 112B and the first ground line 134B are electrically coupled together at both ends.

### Reception Signal Core Line 12B

The reception signal core line 12B has a reception signal line 121B, a second ground line 135B, a reception shield line 122B, and a reception shield cover 123.

The reception signal line 121B has a reception conductor 1211B and a reception conductor cover 1212B.

The second ground line 135B has a second ground conductor 1351B and a second ground conductor cover 1352B.

In this embodiment, the reception signal line 121B and the second ground line 135B are stranded together and formed as a twisted pair cable, as in the second embodiment.

The reception shield line 122B is formed as a braided shield formed of a plurality of wires 1221B braided together, as in the first and second embodiments.

The reception shield line 122B has, at its both ends, a reception shield lead wire 1222B formed of a plurality of wires 1221B stranded together. The reception shield lead wire 1222B is coupled to the second ground line 135B, as in the second embodiment. Thus, the reception shield line 122B and the second ground line 135B are electrically coupled together at both ends.

In this embodiment, a shield lead wire 17B is coupled to the transmission shield line 112B and the reception shield line 122B. Thus, the transmission shield line 112B and the reception shield line 122B are electrically coupled together via the shield lead wire 17B. That is, the transmission shield line 112B, the reception shield line 122B, the first ground line 134B, and the second ground line 135B are electrically coupled together at both ends.

### Advantageous Effects of Third Embodiment

The third embodiment as described above can achieve the following effects.

In this embodiment, the transmission shield line 112B and the reception shield line 122B are electrically coupled to the first ground line 134B and the second ground line 135B.

Thus, even when the wires 1121B, 1221B are broken, the transmission shield line 112B and the reception shield line 122B can release a noise such as an electromagnetic wave via the first ground line 134B and the second ground line 135B. Therefore, the shielding effect can be maintained more securely.

### Fourth Embodiment

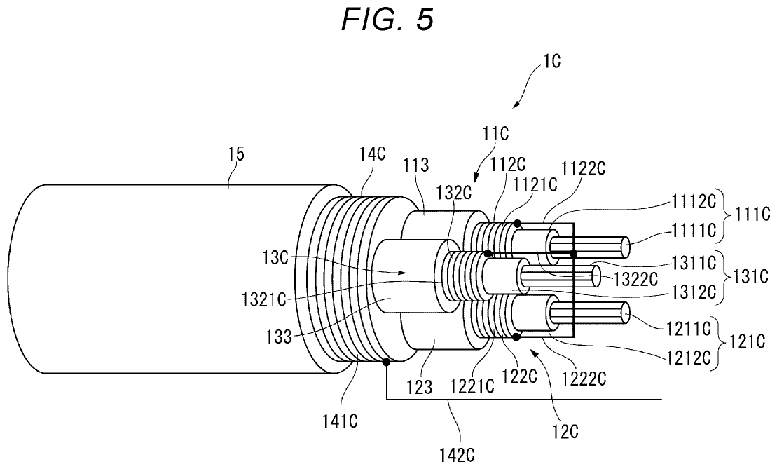

A fourth embodiment of the present disclosure will now be described with reference to FIG. 5. The fourth embodiment is different from the first to third embodiments in that a transmission shield line 112C, a reception shield line 122C, a ground shield line 132C, and an outer circumferential shield line 14C are formed as helically wrapped shields helically wrapped with wires 1121C, 1221C, 1321C, 141C, respectively.

In the fourth embodiment, a component identical or similar to that in the first to third embodiments is denoted by the same reference sign and its description is omitted or simplified.

FIG. 5 is a partly broken cross-sectional view showing essential parts at an end of a cable 1C according to the fourth embodiment.

As shown in FIG. 5, the cable 1C has a transmission signal core line 11C, a reception signal core line 12C, and a ground core line 13C.

### Transmission Signal Core Line 11C

The transmission signal core line 11C has a transmission signal line 111C, a transmission shield line 112C, and a transmission shield cover 113.

The transmission signal line 111C has a transmission conductor 1111C and a transmission conductor cover 1112C.

In this embodiment, the transmission shield line 112C is formed as a helically wrapped shield helically wrapped with a wire 1121C. The transmission shield line 112C has, at its both ends, a transmission shield lead wire 1122C formed as an extension of the wire 1121C.

### Reception Signal Core Line 12C

The reception signal core line 12C has a reception signal line 121C, a reception shield line 122C, and a reception shield cover 123.

The reception signal line 121C has a reception conductor 1211C and a reception conductor cover 1212C.

In this embodiment, the reception shield line 122C is formed as a helically wrapped shield helically wrapped with a wire 1221C. The reception shield line 122C has, at its both ends, a reception shield lead wire 1222C formed as an extension of the wire 1221C.

### Ground Core Line 13C

The ground core line 13C has a ground line 131C, a ground shield line 132C, and a ground shield cover 133.

The ground line 131C has a ground conductor 1311C and a ground conductor over 1312C.

In this embodiment, the ground shield line 132C is formed as a helically wrapped shield helically wrapped with a wire 1321C. The ground shield line 132C has, at its both ends, a ground shield lead wire 1322C formed as an extension of the wire 1321C.

### Outer Circumferential Shield Line 14C

The outer circumferential shield line 14C covers the transmission signal core line 11C, the reception signal core line 12C, and the ground core line 13C.

In this embodiment, the outer circumferential shield line 14C is formed as a helically wrapped shield helically wrapped with a wire 141C. The outer circumferential shield line 14C has, at its both ends, an outer circumferential shield lead wire 142C formed as an extension of the wire 141C.

In this embodiment, the outer circumferential shield lead wire 142C is electrically coupled to the probe frame ground 213 of the probe casing 21 and the control device frame ground 312 of the control device casing 31, as in the first to third embodiments.

### Coupling between Ground Line 131C and Respective Shield Lines 112C, 122C, 132C

As shown in FIG. 5, at the one end of the cable 1C, the transmission shield lead wire 1122C, the reception shield lead wire 1222C, and the ground shield lead wire 1322C, and the ground conductor 1311C are coupled together, as in the first embodiment. Thus, the transmission shield line 112C, the reception shield line 122C, and the ground shield line 132C are electrically coupled to the ground line 131C.

At the other end of the cable 1C, the transmission shield line 112C, the reception shield line 122C, and the ground shield line 132C are electrically coupled to the ground line 131C, similarly to the above.

Thus, the transmission shield line 112C, the reception shield line 122C, the ground shield line 132C, and the ground line 131C are electrically coupled together at both ends.

### Advantageous Effects of Fourth Embodiment

The fourth embodiment as described above can achieve the following effects.

In this embodiment, the transmission shield line 112C, the reception shield line 122C, the ground shield line 132C, and the ground line 131C are electrically coupled together at both ends.

Therefore, even when the wires 1121C, 1221C, 1321C are broken, the shielding effect can be maintained, as in the first embodiment. Also, the transmission shield line 112C, the reception shield line 122C, the ground shield line 132C, and the outer circumferential shield line 14C are formed as helically wrapped shields helically wrapped with the wires 1121C, 1221C, 1321C, 141C, respectively, and therefore even more flexible than when formed as braided shields. Thus, the wires 1121C, 1221C, 1321C, 141C can be made less likely to be broken when the cable 1C is bent. This can restrain a reduction in the shielding effect.

### Modification Examples

The present disclosure is not limited to the above embodiments and includes modifications, improvements and the like within a range that can achieve the object of the present disclosure.

In the embodiments, the connector unit 16 is provided with the first common ground terminal 1622 and the second common ground terminal 1623. However, this is not limiting.

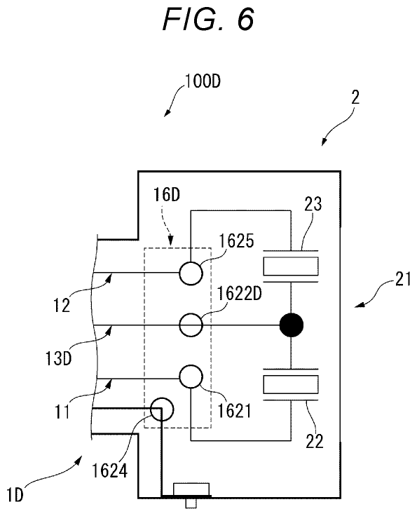

FIG. 6 is a block diagram showing essential parts of an ultrasonic device 100D according to a modification example. As shown in FIG. 6, a connector unit 16D provided at both ends of a cable 1D may be provided with only one common ground terminal 1622D coupled to a ground line of a ground core line 13D. In this case, the ground line is electrically coupled to the transmitting element 22 and the receiving element 23 via the common ground terminal 1622D.

In the first and fourth embodiment, the transmission shield line 112, 112C, the reception shield line 122, 122C, the ground shield line 132, 132C, and the ground line 131, 131C are electrically coupled together at both ends. However, this is not limiting. For example, the transmission shield line 112, 112C, the reception shield line 122, 122C, the ground shield line 132, 132C, and the ground line 131, 131C may be electrically coupled together at the connector unit 16. In this case, the transmission shield line 112, 112C, the reception shield line 122, 122C, the ground shield line 132, 132C, and the ground line 131, 131C may be coupled to a common coupling terminal and thus electrically coupled together.

In the second embodiment, the transmission shield line 112A and the first ground line 134A are electrically coupled together at both ends. However, this is not limiting. For example, the transmission shield line 112A and the first ground line 134A may be electrically coupled together at the connector unit 16. In this case, the transmission shield line 112A and the first ground line 134A may be coupled to a common coupling terminal and thus electrically coupled together.

Similarly, the reception shield line 122A and the second ground line 135A are electrically coupled together at both ends. However, this is not limiting. For example, the reception shield line 122A and the second ground line 135A may be electrically coupled together at the connector unit 16. In this case, the reception shield line 122A and the second ground line 135A may be coupled to a common coupling terminal and thus electrically coupled together.

In the third embodiment, the transmission shield line 112B, the reception shield line 122B, the first ground line 134B, and the second ground line 135B are electrically coupled together at both ends. However, this is not limiting. For example, the transmission shield line 112B, the reception shield line 122B, the first ground line 134B, and the second ground line 135B may be electrically coupled together at the connector unit 16. In this case, the transmission shield line 112B, the reception shield line 122B, the first ground line 134B, and the second ground line 135B maybe coupled to a common coupling terminal and thus electrically coupled together.

In the first embodiment, the transmission shield line 112, the reception shield line 122, the ground shield line 132, and the outer circumferential shield line 14 are formed as braided shields. However, this is not limiting. For example, the transmission shield line 112, the reception shield line 122, and the ground shield line 132 may be formed as helically wrapped shields, and the outer circumferential shield line 14 may be formed as a braided shield. Each of the shield lines 112, 122, 132, 14 may be formed either as a braided shield or as a helically wrapped shield.

In the second embodiment, the transmission shield line 112A, the reception shield line 122A, and the outer circumferential shield line 14 are formed as braided shields. However, this is not limiting. For example, the transmission shield line 112A and the reception shield line 122A may be formed as helically wrapped shields, and the outer circumferential shield line 14 maybe formed as a braided shield. Each of the shield lines 112A, 122A, 14 may be formed either as a braided shield or as a helically wrapped shield.

In the third embodiment, the transmission shield line 112B, the reception shield line 122B, and the outer circumferential shield line 14 are formed as braided shields. However, this is not limiting. For example, the transmission shield line 112B and the reception shield line 122B may be formed as helically wrapped shields, and the outer circumferential shield line 14 maybe formed as a braided shield. Each of the shield lines 112B, 122B, 14 may be formed either as a braided shield or as a helically wrapped shield.

In the embodiments, the transmitting circuit 321 and the receiving circuit 322 are provided at the circuit board 32 in the control device 3. However, this is not limiting. For example, a circuit board may be provided in the ultrasonic sensor 2, and a transmitting circuit and a receiving circuit may be provided at this circuit board.

In the embodiments, the transmitting element 22 and the receiving element 23 are provided in the ultrasonic sensor 2. However, this is not limiting. For example, a transmitting/receiving element that can transmit and receive an ultrasonic wave may be provided in the ultrasonic sensor 2, and the transmitting/receiving element may be configured to be able to switch between transmission and reception of an ultrasonic wave.

In the embodiments, the ultrasonic device 100 is formed as a distance measuring device. However, this is not limiting. For example, the ultrasonic device 100 may be applied to an ultrasonic measuring device measuring an interior tomographic image of a structure according to a result of transmission/reception of an ultrasonic wave.

In the embodiments, the cable 1, LA, 1B, 1C, 1D electrically couples the ultrasonic sensor 2 and the control device 3 to each other. However, this is not limiting. The cable may be used as a cable electrically coupling various devices together.

Also, a specific structure for embodying the present disclosure may be formed by an appropriate combination of the embodiments and modification examples within a range that can achieve the object of the present disclosure, or may be properly changed to another structure.

What is claimed is:

1. A cable comprising:
a core line including a signal line transmitting a signal, a ground line having a ground potential, and a shield line covering the signal line and the ground line,
the ground line and the shield line being electrically coupled together.

2. The cable according to claim 1, wherein
the shield line is formed of a plurality of wires formed of a conductor and braided together.

3. The cable according to claim 1, wherein
the shield line is formed of a wire formed of a conductor and helically wrapped.

4. The cable according to claim 1, wherein
the shield line includes a signal shield line covering the signal line, and a ground shield line covering the ground line, and
the signal shield line and the ground shield line are electrically coupled to the ground line.

5. The cable according to claim 4, wherein
the signal line includes a transmission signal line transmitting a drive signal between a first piezoelectric element transmitting an ultrasonic wave and a transmitting circuit controlling transmission of an ultrasonic wave, and a reception signal line transmitting a reception signal between a second piezoelectric element receiving an ultrasonic wave and a receiving circuit controlling reception of an ultrasonic wave,
the signal shield line includes a transmission shield line covering the transmission signal line, and a reception shield line covering the reception signal line, and
the transmission shield line and the reception shield line are electrically coupled to the ground line.

6. The cable according to claim 5, wherein
the ground line includes a first ground line and a second ground line,
the transmission shield line is electrically coupled to the first ground line, and
the reception shield line is electrically coupled to the second ground line.

7. The cable according to claim 5, wherein
the ground line includes a first ground line and a second ground line, and
the transmission shield line and the reception shield line are electrically coupled to the first ground line and the second ground line.

8. The cable according to claim 1, wherein
the ground line and the shield line are electrically coupled together at both ends.

9. An ultrasonic device comprising:
the cable according to claim 1;
an ultrasonic sensor coupled to one end of the cable; and
a control unit coupled to the other end of the cable and controlling the ultrasonic sensor.
